(19) United States
(12) Patent Application Publication
(10) Pub. No.: US 2006/0076808 A1
(43) Pub. Date: Apr. 13, 2006

(54) Bicycle seat

(75) Inventor: Erhard Buchel, (US)

Correspondence Address: REED SMITH LLP;Suite 1400, 3110 Fairview Park Drive, Falls Church, VA, 22042, US

(73) Assignee: Buchel GmbH & Co. Faharzeugteilefabrik KG.

(21) Appl. No.: 11/249,336

(22) Filed: Oct. 14, 2005

(30) Foreign Application Priority Data
Oct. 12, 2004 (DE) 20 2004 016000.5

(51) Int. Cl. B62J 1/22

(52) U.S. Cl. 297/214; 297/195.1; 297/202

(57) ABSTRACT

A bicycle seat according to the invention comprises a shell, an elastic filling which is arranged lying over the shell, and a seat covering. The seat covering comprises at least one opening which is closed by a decorative pattern foil.

The invention relates to a bicycle seat.

From the state of the art, bicycle seats are known comprising a shell, an elastic filling which is arranged lying over the shell, and a seat covering.

From EP 0 903 321 B1, a bicycle seat is known in which an ornamental element is arranged on the inner side of the filling or in between two filling layers of the filling and which is visible from the outside through an optical transparent zone of the seat covering. Such a bicycle seat is relatively difficult to manufacture. It is necessary to choose a transparent material for the filling material of the filling layer.

The aim of the invention is to develop further such a bicycle seat maintaining or improving the visual effects so that it can be produced easier and at lower costs.

This aim is accomplished by a seat covering comprising at least one opening which is closed by decorative pattern foil. Thereby multiple decorative effects can be accomplished in a simple manner by simple means since the means by which the decorative effects are accomplished can be incorporated into the seat covering in a simple manner. Such a bicycle seat can be produced easily, since at least one layer can be saved. There is no need to arrange an ornamental element between the inside of the filling or between two layers of the filling and to form a zone of the seat covering transparent additional thereto. Furthermore, arbitrary and especially cheaper materials can be used for the filling.

A preferred embodiment of the invention is characterized in that the pattern foil is shrink-wrapped into the seat covering whereby in a simple manner a plane surface of the seat covering can be accomplished so that the decorative effect does not result in a disadvantageous effect in using the seat.

Another preferred embodiment of the invention is characterized in that the pattern foil comprises three-dimensional effects. This makes the foil especially decorative.

Another preferred embodiment of the invention is characterized in that the pattern foil is transparent. In this case the decorative effect is influenced or mainly achieved by the surface structure of the materials of the seat which lie under the pattern foil. The character, the condition and, as the case may be, defects wear off, if present, of the elastic filling can be observed and controlled from the outside in an easy manner.

Another preferred embodiment of the invention is characterized by a covering layer on the inside lying side of the pattern foil. Thereby the three-dimensional effects catch the eye particularly clearly. Furthermore, additional decorative effects can be achieved independently from the material as they exist under the seat covering.

Another preferred embodiment of the invention is characterized in that the covering layer of the pattern foil is a varnish layer which can be applied during or after the production of the pattern foil and still when the pattern foil is prepared for shrink-wrapping into a special type of seat. Furthermore, this yields to less cost of material.

Another preferred embodiment of the invention is characterized in that the covering layer of the pattern foil is a covering foil joint to the pattern foil. Such foils can be laminated especially good and permanent.

Another preferred embodiment of the invention is characterized in that the pattern foil is joint to the covering foil by fusing whereby it is achieved that the pattern remains intact also during a long term of the use of the seat.

Another preferred embodiment of the invention is characterized in that the covering foil is a PVC-, PP- or PE-foil, whereby such materials are especially suited for fusing and the operating conditions of bicycle seats.

Another preferred embodiment of the invention is characterized in that the covering layer is a textile material whereby in a simple manner use can be made of the decorative effects of the textile material.

Another preferred embodiment of the present invention is characterized in that on top of the covering layer the pattern foil an advertising symbol or an advertising art is applied whereby the seat can be designed especially decoratively and in addition can be used for promotional purposes.

Another preferred embodiment of the invention is characterized in that the covering layer itself is provided with a surface pattern. As foils with a big plurality of pattern surfaces are already available in retail by using such a foil on the lower side of the pattern foil additional pattern effects can be achieved without additional effort.

The invention becomes more clear by the subsequent detailed description wherein the figures show the following:

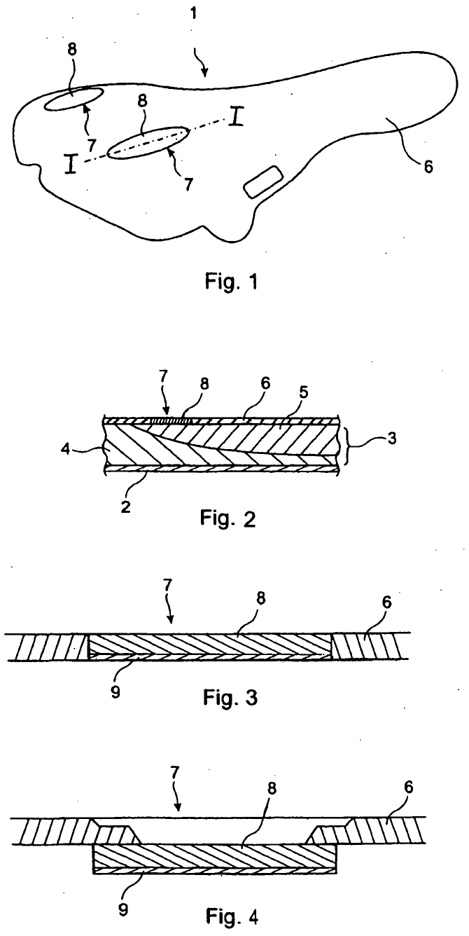

FIG. 1 shows a perspective view of a bicycle seat according to the invention with two openings which are closed by a pattern foil.

FIG. 2 shows a cut along line I-I in FIG. 1.

FIG. 3 shows an enlarged sectional view along line I-I in FIG. 1 through an opening formed according to a first embodiment of the invention.

FIG. 4 shows an enlarged sectional view along line 1-1 in FIG. 1 through an opening formed according to a second embodiment of the invention.

FIG. 1 shows a perspective view of a bicycle seat 1 with a seat covering 6 and with two openings 7 formed in the seat covering 6.

Those openings 7 are arranged next to each other in the rear part of the seat covering 6 and are closed by the pattern foil 8. A cut line I-I proceeds in the direction of the seat to the front through the first one of the two openings 7 in the covering 6.

FIG. 2 shows a sectional view through the first opening 7 along line I-I in FIG. 1.

At the bottom a shell 2 can be seen to which a filling 3 is applied. At the outer portions of he bicycle seat 1, the filling 3 is formed by the filling layer 4 only; in the center of the bicycle seat 1 the filling 3 comprises a lower filling layer 4 and a gel layer 5, which is arranged on top of the filling layer 4. In between the outer portions and the center of the bicycle seat 1, the thickness of the gel layer 5 decreases to the outer portions. Thereby, an optimal padding is achieved with a reduced use of the gel material in the gel layer 5.

The filling layer 4 and the gel layer 5 have a different elasticity. By the gradient and the arrangement of the filling layer 4 and the gel layer 5, the characteristics of the cushion of the bicycle seat 1 are determined. The cushion can be customized individually to the needs which result from the different load on the various portions of the bicycle seat 1.

On top of the filling 3 the covering 6, which is shown proceeding horizontally in FIG. 2, is arranged and in which the opening 7 can be identified easily. A portion of the pattern foil 8, which has the same dimensions as the opening 7 and who's thickness substantially corresponds to the thickness of the covering 6, is inserted accurate in size to the opening 7. Accordingly, the opening 7 is closed by the pattern foil 8.

According to the choice of the pattern foil 8, a plurality of visual and decorative effects can be achieved, which are especially attractive if the pattern foil 8 is formed as a transparent so-called 3-D-foil.

FIG. 3 shows an enlarged sectional view along line I-I according to a first embodiment of the invention. In FIGS. 3 and 4, the filling 3 is not shown.

In this embodiment of the invention, the pattern foil 8 is inserted into the opening 7 of the covering 6 accurate size and it is situated at the same height as the covering 6. FIG. 3 shows that the lateral rim of the pattern foil 8 terminates accurate in size with the rim of the covering 6. Alternatively, the lateral rim of the pattern foil 8 can be fused or glued to the rim of the covering 6.

In the embodiment according the FIG. 3 in addition to the advantages described above, a smooth surface of the covering 6 is achieved so that there are no edges against which the pants of the cyclist can rub and wear off or though which holes are torn into the cyclist's pants.

Furthermore, the pattern foil 8 comprises an optional covering layer 9 at its lower side which can be formed as a varnish layer or as a pattern foil, which is fused, glued or otherwise joined to the covering foil or as a textile material.

As the covering layer 9 is protected from outside influences by the pattern foil 8, the material for the covering layer 9 can be selected from a larger group of materials compared to the pattern foil 8. Furthermore, in this embodiment less material of the, as the case may be, optical complex and therefore more expensive material of the covering layer 9 is needed.

In particular, the covering layer 9 can be made of a textile material. Thereby use can be made of the properties of textile materials.

FIG. 4 shows an enlarged sectional view along line I-I according to a second embodiment of the invention.

Here, the opening 7 of the covering 6 comprises a cascade rim, and the pattern foil 8 is not formed in the same plane as the covering 6 like in FIG. 3, but rather it is located below the opening 7 and it is fixed to the lower side of the covering 6. Accordingly, a cavity is formed at the place of the opening 7 in the surface of the bicycle seat 1, whereby sensitive body parts of the cyclist are released so that unpleasant and hurting dents can be avoided.

The opening 7 of the covering 6 can be produced according to the embodiment shown in FIG. 4 by fusing, gluing or laminating the pattern foil 8 to the covering 6 from below. Thereby, the portion of the pattern foil 8 needs not to have exactly the same dimensions as the opening 7 like in FIG. 3, but it has larger dimensions as the opening.

By the cascade form of the rim of the opening 7 without having sharp edges, it is avoided that the pants of the cyclist are worn out excessively or that holes are torn into the cyclist's pants.

In this embodiment, the pattern foil 8 comprises a covering layer 9, too, which can be formed as a varnish layer, as a pattern foil which is fused or otherwise joined to the covering foil or as a textile material, as well.

1. A bicycle seat, comprising a shell, an elastic filling which is arranged lying over the shell, and a seat covering, characterized in that
the seat covering comprises at least one opening which is closed by a decorative pattern foil.

2. A bicycle seat according to claim 1, characterized in that the pattern foil is shrink wrapped into the seat covering.

3. A bicycle seat according to claim 1, characterized in that the pattern foil comprises three-dimensional effects.

4. A bicycle seat according to claim 1, characterized in that the pattern foil is transparent.

5. A bicycle seat according to claim 1, characterized in that
the elastic filling comprises a filling layer and a gel layer arranged between the filling layer and the seat covering.

6. The bicycle seat according to claim 5, characterized by a covering layer on the elastic filling and especially on the side of the pattern foil facing the gel layer.

7. The bicycle seat according to claim 6, characterized in that
the covering layer of the pattern foil is a varnish layer, a covering foil joined with the pattern foil, is a PVC-, PP- or PE-foil or a textile material.

8. The bicycle seat according to claim 7, characterized in that
the pattern foil is joined to the covering foil by fusing.

9. The bicycle seat according to claim 6, characterized in that
the covering layer itself is provided with a surface pattern.

10. The bicycle seat according to claim 1, characterized in that
the pattern foil is inserted accurate in size into the opening of the seat covering and is situated at the same height as the seat covering.

11. The bicycle seat according to claim 1, characterized in that
the pattern foil is located below the opening and at the lower side of the seat covering.

12. The bicycle seat according to claim 11, characterized in that
the rim of the opening of the set covering comprises cascade formed rim.
